(19) United States
(12) Patent Application Publication
(10) Pub. No.: US 2011/0252049 A1
(43) Pub. Date: Oct. 13, 2011

(54) FUNCTION EXECUTION USING SQL

(76) Inventors: Dan Cristian Marinescu, Puteaux (FR); Adrian Dragusanu, Poissy (FR)

(21) Appl. No.: 12/755,982

(22) Filed: Apr. 7, 2010

(51) Int. Cl. G06F 17/30

(52) U.S. Cl. 707/769; 707/803; 707/E17.014; 707/E17.044; 707/E17.005

(57) ABSTRACT

A system to execute a function includes determination of a plurality of parameters associated with a function, determination of columns of a table based on the plurality of parameters, and generation of metadata defining the columns of the table and mapping the columns to associated ones of the plurality of parameters. Also included may be generation of a Structured Query Language query of the table based on the metadata, the query specifying a value of a first column of the table, assignment of the value to one of the plurality of parameters based on the metadata, and calling of the function with the assigned parameter value.

### BACKGROUND

Conventional enterprise computing systems may utilize data provided by many disparate sources. These data sources may include one or more relational databases, Online Analytical Processing (OLAP) databases, text files, application servers, etc. The enterprise computing system may connect to each datasource via a corresponding software connector. For example, to retrieve data from a datasource, the enterprise computing system transmits a Structured Query Language (SQL) query to the software connector corresponding to the datasource. By using such software connectors, the different data formats and access techniques of the datasources become substantially transparent to the enterprise computing system.

The above-described architecture is insufficient for some potential sources of data. An Application Programming Interface (API), for example, may provide functions which return data to their callers and/or allow a caller to manipulate external data. However, no system currently exists to efficiently call a function and retrieve results thereof based on an SQL query.

### BRIEF DESCRIPTION OF THE DRAWINGS

FIG. 1 is a block diagram of a system according to some embodiments.

FIG. 2 is a flow diagram of a process according to some embodiments.

FIG. 3 is a view of an interface provided by an information designer according to some embodiments.

FIG. 4 is a view of an interface provided by an information designer according to some embodiments.

FIG. 5 is a view of an interface provided by an information designer according to some embodiments.

FIG. 6 is a view of an interface provided by an information designer according to some embodiments.

FIG. 7 is a view of an interface provided by an information designer according to some embodiments.

FIG. 8 is a flow diagram of a process according to some embodiments.

FIG. 9 is a view of an interface provided by an information designer according to some embodiments.

FIG. 10 is a view of an interface provided by an information designer according to some embodiments.

FIG. 11 is a block diagram of a system according to some embodiments.

FIG. 12 is a flow diagram of a process according to some embodiments.

FIG. 13 is a view of an interface according to some embodiments.

FIG. 14 is a view of an interface according to some embodiments.

FIG. 15 is a block diagram of a system according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

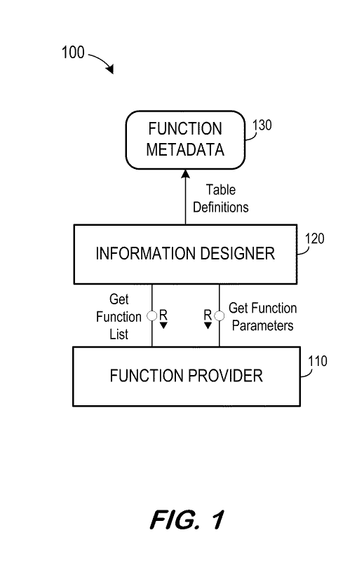

FIG. 1 is a block diagram of system 100 according to some embodiments. The elements of system 100 may operate to generate metadata associated with the parameters of a function. As will be described below, the metadata may be used to call the function based on an SQL query. Moreover, the metadata may be used to generate the SQL query.

Each element of system 100 may be implemented by any suitable combination of hardware (e.g., one or more processors) and/or software (e.g., processor-executable program code). System 100 may include elements in addition to those illustrated, and some embodiments may omit one or more elements of system 100.

Function provider 110 may comprise any system exposing a callable API that is or becomes known, including but not limited to an Advanced Business Application Programming (ABAP) application server. The API may include one or more functions, each of which is associated with one or more input parameters and output parameters. Function provider 110 may support a particular protocol for calling its functions, which may depend on the programming language in which the functions are written (e.g., ABAP, Java, C++, etc.).

In some embodiments, information designer 120 receives a list of functions from function provider 110. Information designer 120 may also receive parameters of selected functions from function provider 110 and generate function metadata 130 based thereon. Information designer 120 may comprise a standalone, Web-based or other application executing on any computing device or devices that are or become known.

For a given function, function metadata 130 includes metadata defining one or more “virtual” tables. The tables are referred to as “virtual” because the metadata does not represent physical tables. The virtual tables are representations of the given function, and may be used as described below to formulate SQL queries on the function and to return SQL-formatted results. As will also be described below, the metadata may associate particular columns of each table with particular parameters of the given function.

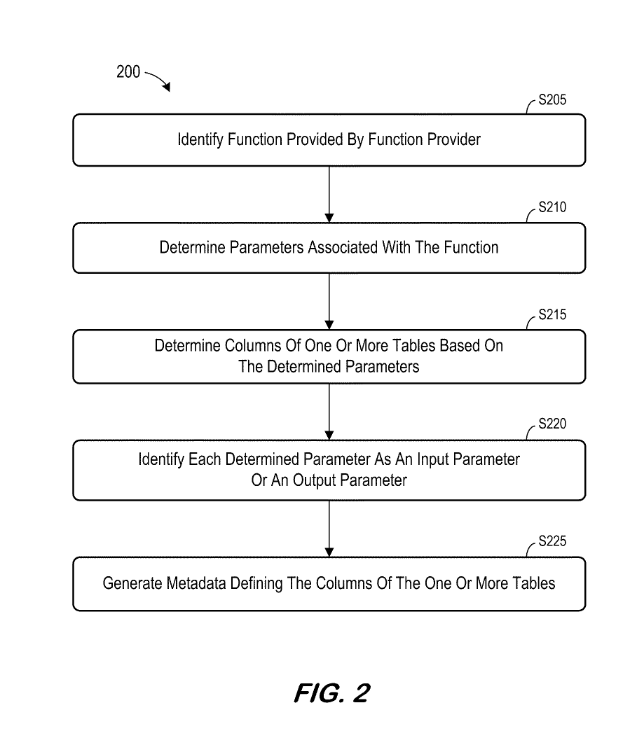

FIG. 2 is a flow diagram of process 200 according to some embodiments. Process 200, and all other processes described herein, may be executed by computer hardware and/or embodied in program code stored on a tangible computer-readable medium. Process 200 may be performed by information designer 120 of system 100, but embodiments are not limited thereto.

Initially, at 5205, a function provided by a function provider is identified. Any system for identifying a function may be used at 5205 in some embodiments. For example, the function may be identified from documentation provided by a developer of function provider 110.

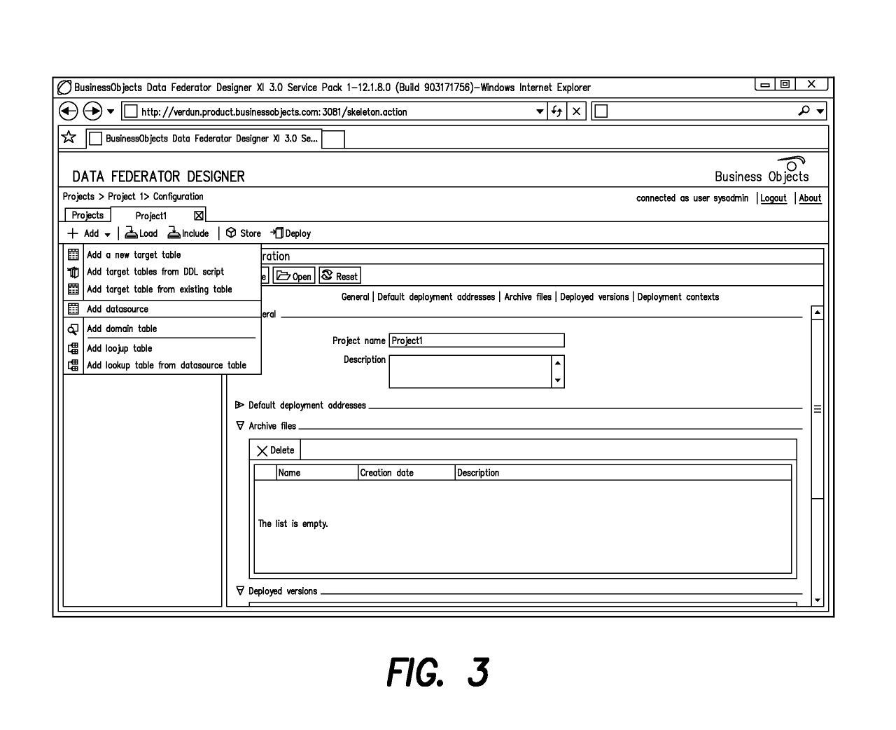

FIGS. 3 through 7 include user interfaces illustrating identification of a function according to some embodiments. The user interfaces are shown as displayed in a Web browser window. Accordingly, the user interfaces may be provided by a Web-based application (e.g., information designer 120) and presented by a display device of a client device in which the Web browser is executing.

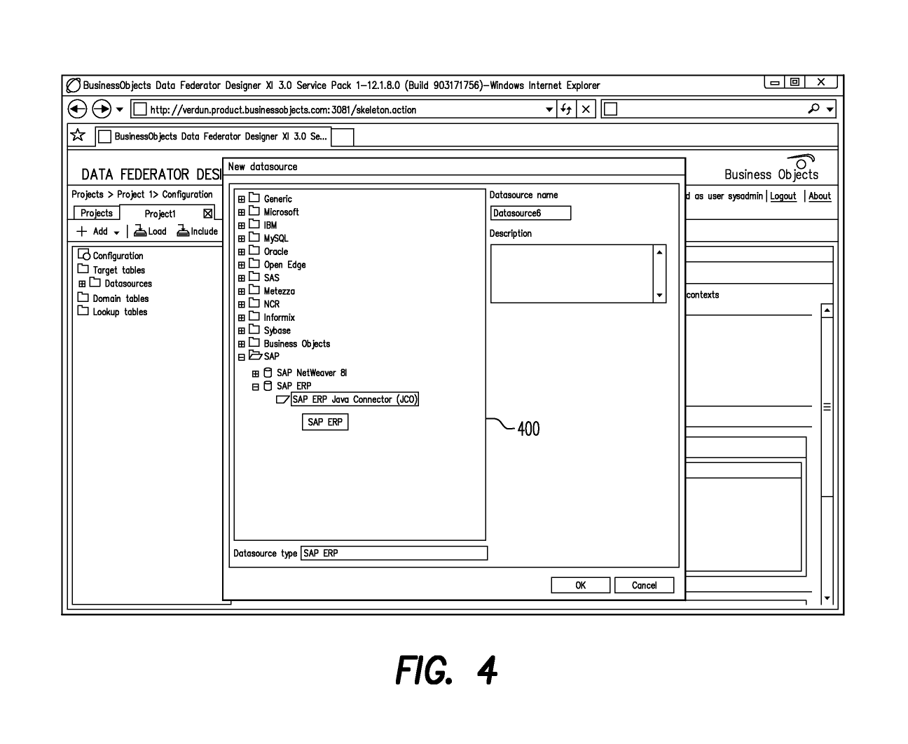

As shown in FIG. 3, an operator has selected the “Add datasource” menu item from user interface 300. Window 400 of FIG. 4 is displayed in response to this selection. Window 400 lists several different datasource vendors. Each vendor may be expanded to select a particular type of datasource provided thereby. These datasource types may include relational databases, OLAP databases, application files (e.g., spreadsheets), and other systems. In the present example, vendor SAP is expanded and a datasource type corresponding to an SAP Enterprise Resource Planning (ERP) system is selected. Moreover, the operator has assigned the name “Datasource6” to the datasource.

It will be assumed that the present example illustrates creation of a datasource for a Java target system. Accordingly, since an SAP Enterprise Resource Planning (ERP) system provides an API written in ABAP, the target system may use the SAP ERP Java Connector adapter for calling a function from this datasource. In contrast, no adapter is needed for calling a function from a Java API, and Java native calls may be used (using Java Native Interface) to call a function from an API written in C++.

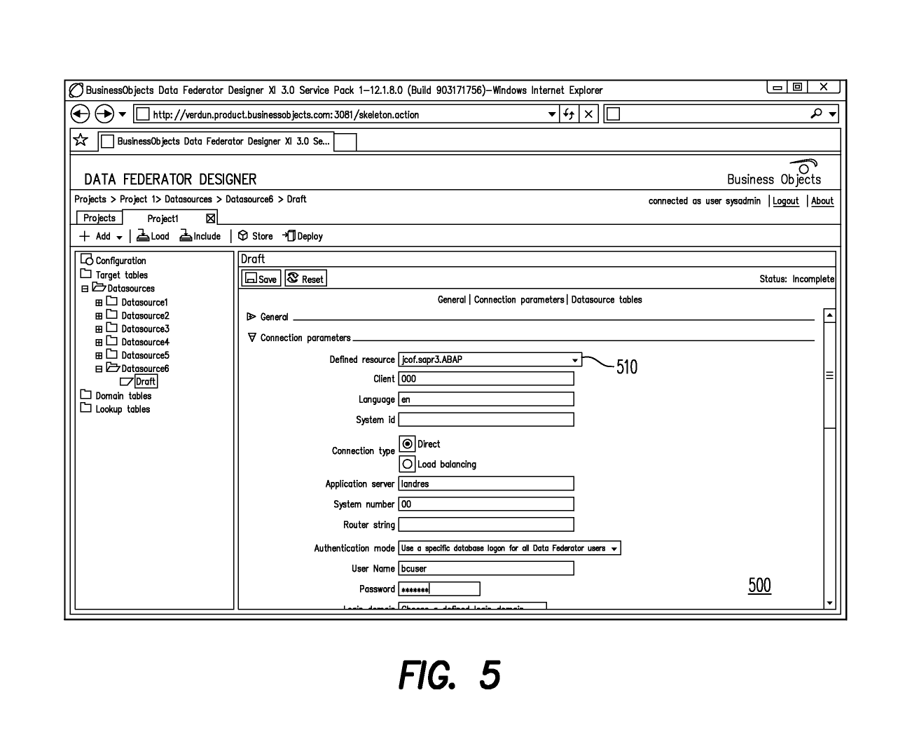

FIG. 5 shows interface 500 to define properties of a connector to be associated with the datasource. For example, field 510 allows the operator to specify a configuration file for the connector. The connector will be used, in conjunction with the already-defined adapter, to communicate with the datasource during process 200. The connector may also be used to create a function call based on an SQL query as described below with respect to process 1100.

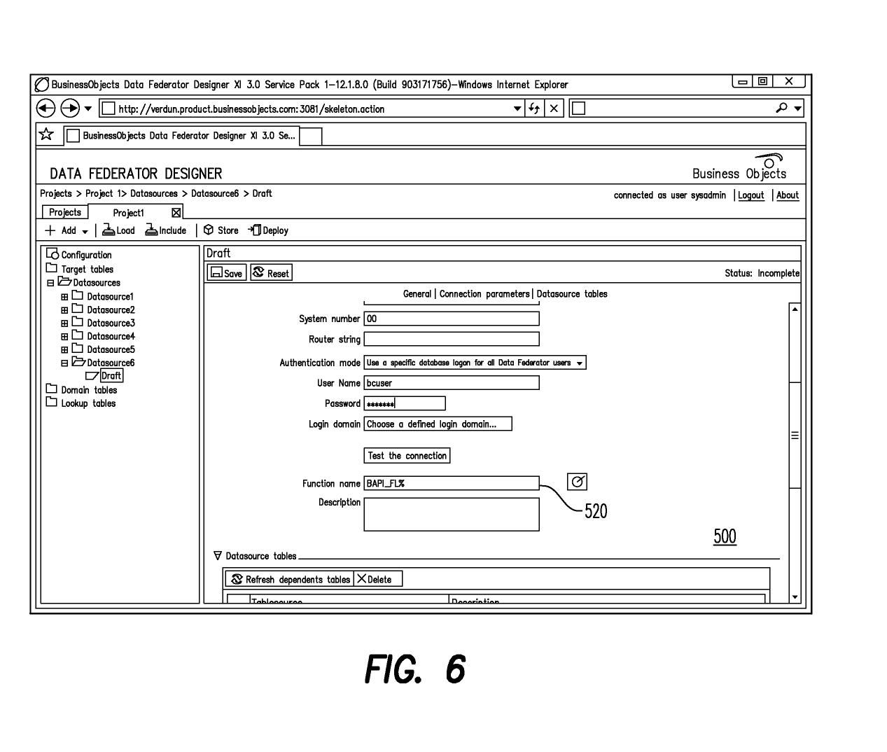

FIG. 6 illustrates an area of interface 500 not shown in FIG. 5. Field 520 allows the operator to perform a wildcard search of function names provided by the datasource. This type of searching is provided by ABAP via the SAP ERP Java Connector adapter, but embodiments are not limited thereto.

Generally, an adapter for a datasource may provide searching of available functions based on metadata including, but not limited to, name, class name, and package name. Languages such as Java and C++, for example, provide an introspection feature for discovery of all the classes and functions of a deployed package. This feature may be combined with a search algorithm to retrieve available functions associated with specified metadata.

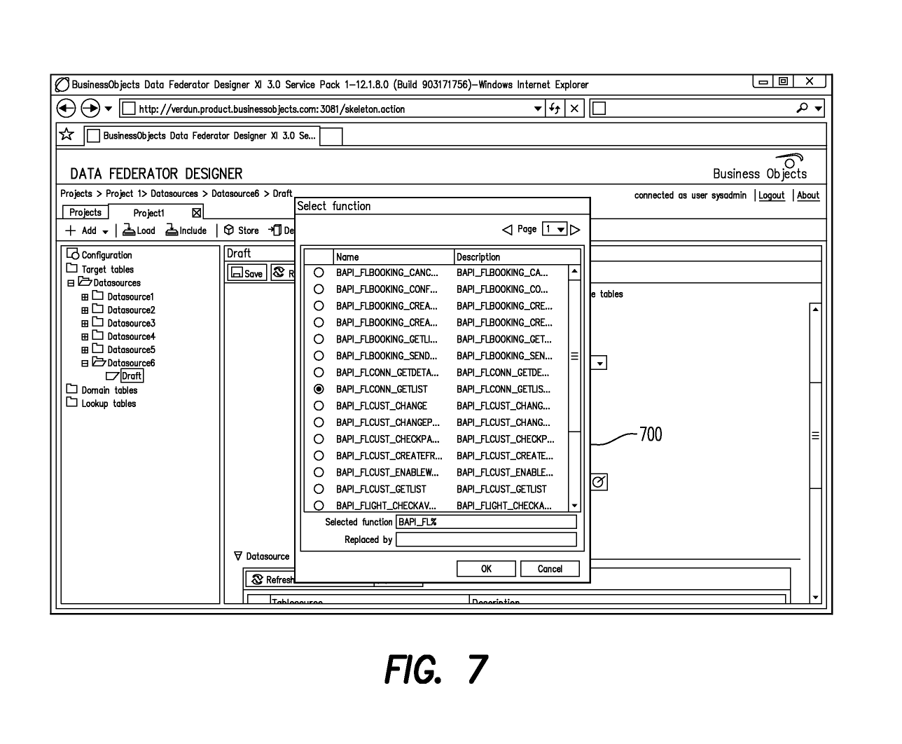

Window 700 of FIG. 7 provides a list of available functions which satisfy the wildcard search. The operator has selected the function BAPI_FLCONN_GETLIST from the list in order to identify the function at S205. S205 may also consist of identifying any functions that must be executed prior to calling the identified function, such as constructors and initialization functions. These functions may be identified automatically using introspection or other functions provided by the function's language for this purpose. Alternatively, an operator may manually identify these functions.

Parameters associated with the identified function are determined at S210. Also determined at S210 may be parameters of any constructors and/or initialization functions identified at S205. Again, ABAP provides functions to retrieve function parameters, and other languages may provide similar features. In this regard, parameters of a function may be determined through introspection and searching as described above.

Columns of one or more tables are determined based on the function parameters at S215. Each column represents a function parameter. As described above, the tables are not physical tables for storing data. Rather, the tables are defined data structures to represent the identified function so that SQL queries on the function may be generated and fulfilled.

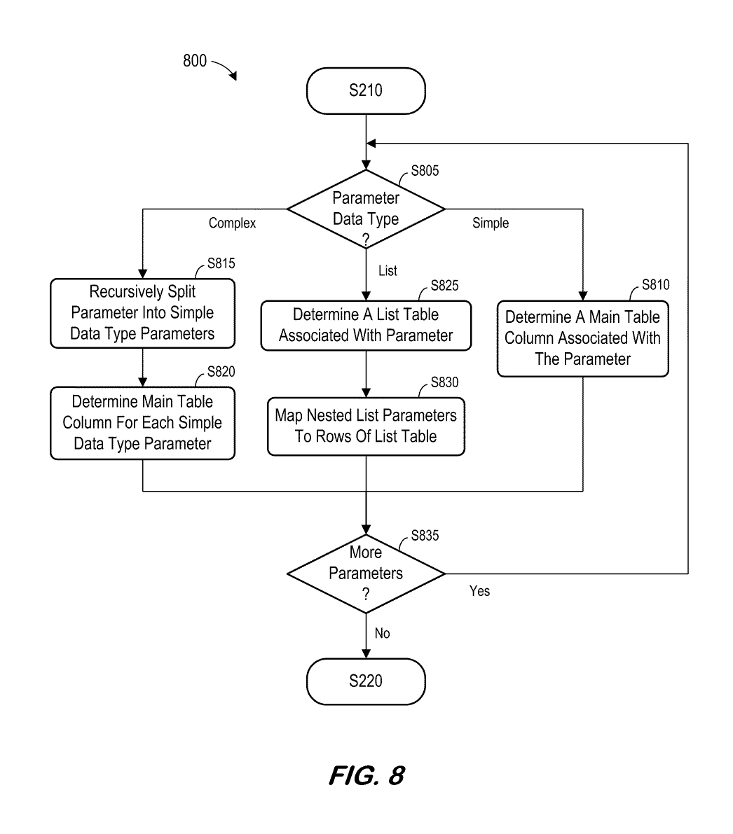

FIG. 8 is a flow diagram of process 800 to determine the columns of the one or more tables based on the parameters according to some embodiments. In this regard, the function is associated with one “main” virtual table and may, as will be described below, be associated with additional virtual tables.

A data type of a first parameter is determined at S805. If the data type of the parameter is “simple” (e.g., string data type, integer data type, float data type, Boolean data type, etc.), a column of the main table is determined and associated with the parameter. In some embodiments, the column name is the name of the parameter. Flow proceeds from S805 to S815 if the determined parameter data type is “complex” (e.g., class data type or structure data type).

At S815, the complex parameter is recursively split into its constituent simple data type parameters. This splitting will create a hierarchy of simple data type parameters. Next, at S820, a main table column is determined for each simple data type parameter of the hierarchy as described above with respect to S810. However, in some embodiments, the name of the table column associated with a given parameter of the hierarchy indicates a parent parameter (if any) of the given parameter. For example, the name of the column may include the name of the given parameter and a prefix including the name of the parent parameter.

If the parameter is determined to exhibit a list data type (e.g., arrays, tables, or vectors of simple and/or complex data types) at S805, a separate list table is associated with the parameter at S825. The name of the list table may include the parameter name and a prefix indicating that the table is associated with a list data type. Each column of the list table is associated with an element of the list parameter. At S830, nested list parameters (if any) are mapped to additional rows of corresponding complex and simple data types for each element of the list parameter.

Flow proceeds to S835 from S810, S820 and S830. If the function is associated with additional parameters, flow returns to S805 for processing as described above. If not, flow continues to S220. Embodiments are not limited to the specific order of steps illustrated in FIG. 8. For example, the columns associated with all parameters of a given data type (i.e., simple, complex, list) may be determined in a single pass, followed by the determination of columns associated with all parameters of a next data type.

Returning to process 200, each determined parameter is identified as an input parameter or as an output parameter at S220. If the programming language of the API does not provide a way of explicitly defining input parameters and output parameters, the operator may be asked to perform the identifications.

Metadata is generated at S225. The metadata defines the columns of one or more tables associated with the identified function. The metadata may also specify whether each parameter is an input parameter or an output parameter based on the identification at S220. Moreover, the metadata may provide a mapping between each column and its associated function parameter. The metadata may be generated in any format, including but not limited to an eXtensible Markup Language (XML) format.

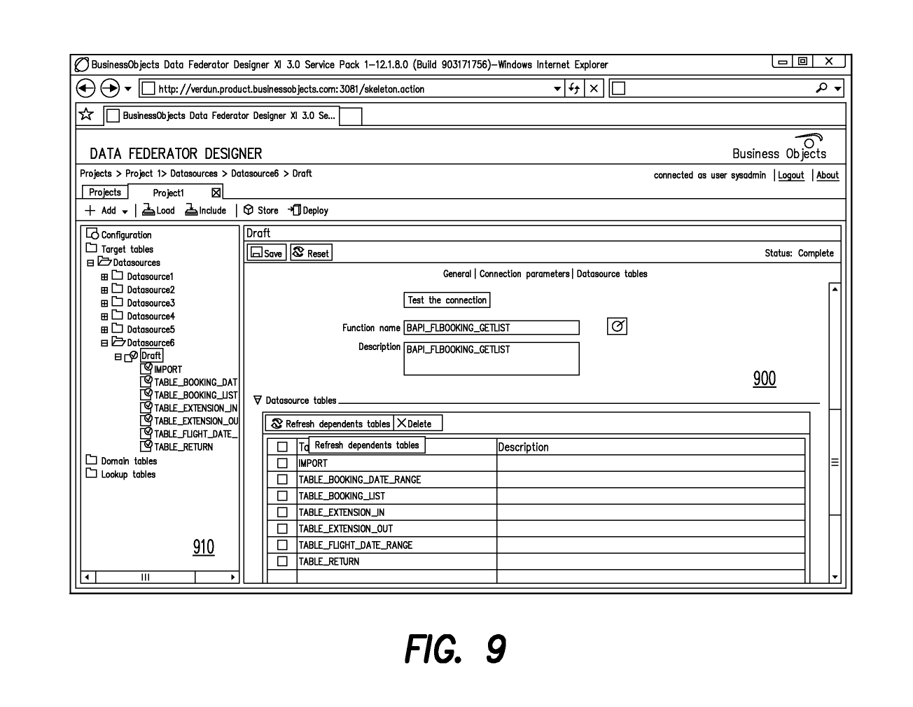

Interface 900 of FIG. 9 lists tables determined based on function parameters according to some embodiments of processes 200 and 800. The tables were determined based on the parameters of the function identified at S205 in the present example. The listing of the tables in interface 900 may be based on the metadata generated at S225.

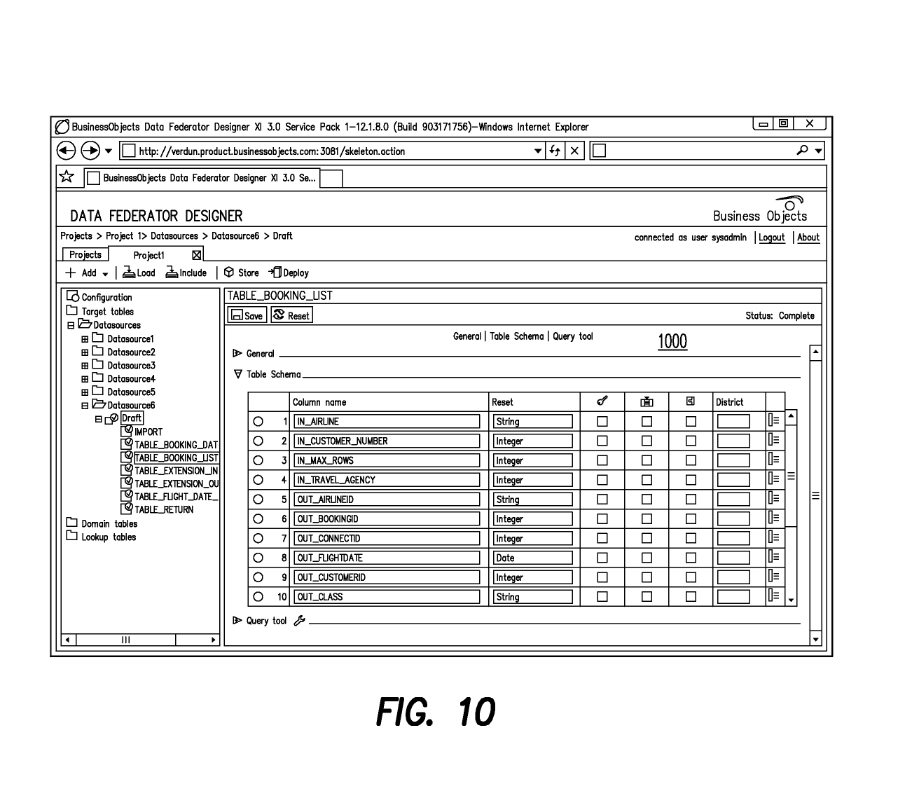

Interface 1000 of FIG. 10 is displayed in response to operator selection of table TABLE_BOOKING_LIST in pane 910. Interface 1000 illustrates the determined columns of table TABLE_BOOKING_LIST. Each column name indicates, using an “IN_” or “OUT_” prefix, whether a parameter associated with the column is an input parameter or an output parameter. The column information presented in interface 1000 may be determined from the metadata generated at S225.

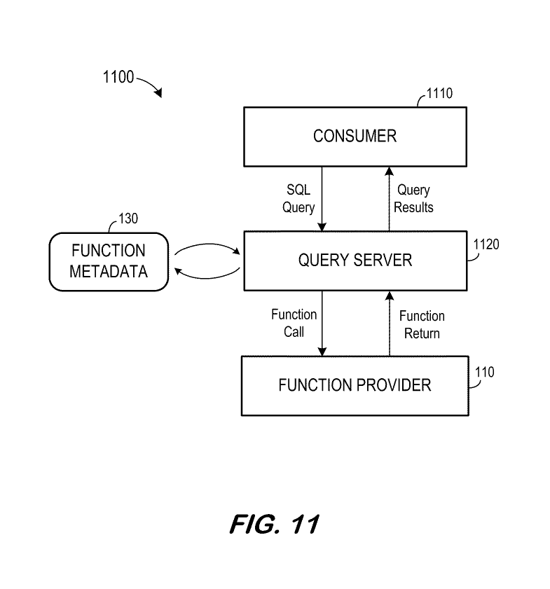

FIG. 11 is a block diagram of system 1100 to execute a function based on an SQL query according to some embodiments. For continuity, system 1100 includes function provider 110 and function metadata 130 of system 100. However, system 1100 may comprise any function provider and corresponding function metadata.

Briefly, and as illustrated, data consumer 1110 provides an SQL query to query server 1120. Query server 1120 determines a function call based on the SQL query and on function metadata 130, and the function call is provided to function provider 110. Function provider 110 executes the function and returns results (e.g., output parameter values) to query server 1120. Query server 1120 then generates SQL query results based on the returned results and on function metadata 130.

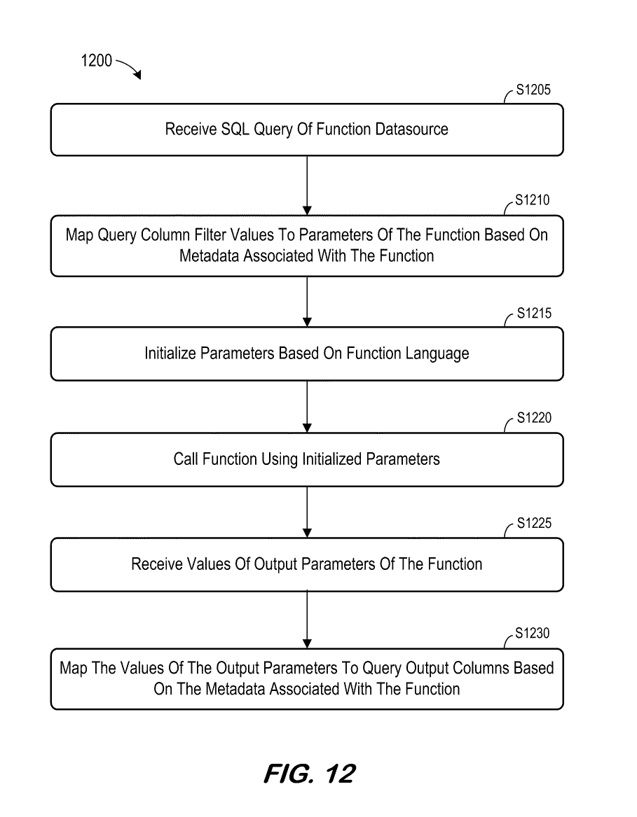

FIG. 12 is a flow diagram of process 1200 to more particularly describe the operation of system 1100 according to some embodiments. Process 1200 is not limited to performance by system 1100.

Initially, at S1205, an SQL query of a function datasource is received. The SQL query may be generated based on function metadata associated with the function. For example, the function metadata may describe virtual tables associated with the function, and the SQL query may select and filter columns of the virtual tables.

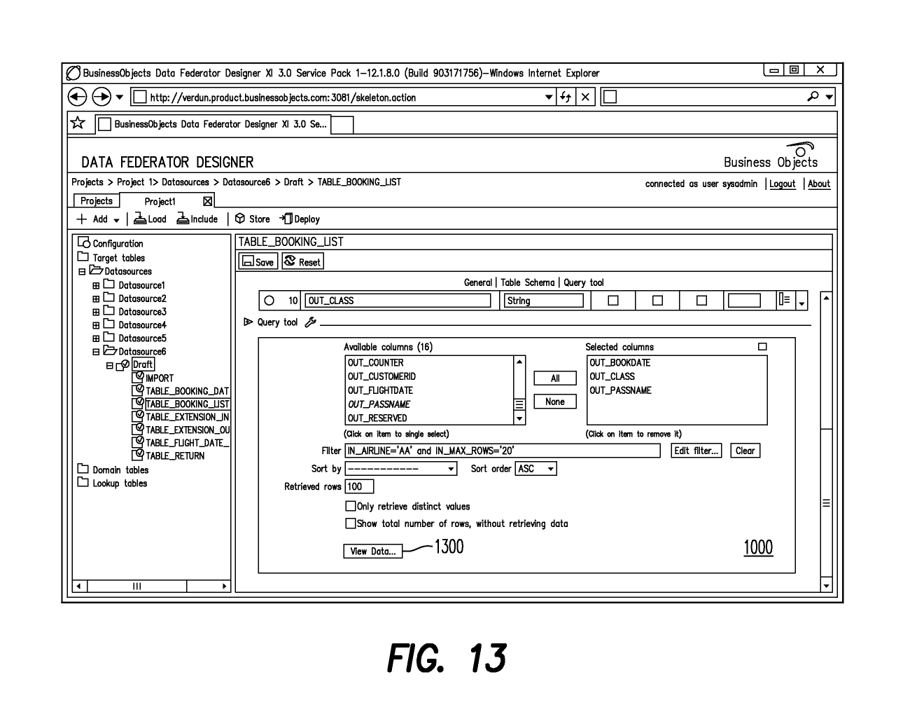

By way of example, FIG. 13 illustrates a Query Tool of interface 1000 which is not fully shown in FIG. 10. The Query tool allows an operator to generate an SQL query based on tables associated with a function datasource, and to execute the query in accordance with embodiments of process 1200. Accordingly, the Query Tool provides functionality attributed to consumer 1110 and query server 1120 of system 1100.

As shown in FIG. 13, the operator has selected three columns of the virtual table TABLE_BOOKING_LIST. The three columns are associated with output parameters of the selected function datasource (i.e., BAPI_FLBOOKING_GETLIST). The operator has also specified filter values (i.e., ‘AA’ and ‘20’) associated with two other columns of the virtual table. These two columns are associated with input parameters of the selected function datasource.

After operator selection of icon 1300, the query column filter values are mapped to parameters of the function based on metadata associated with the function. As described above, the metadata may map columns of the virtual tables to function parameters. In the present example, the value ‘AA’ is mapped to the input parameter associated with column IN_AIRLINE (e.g., parameter “AIRLINE”), and the value ‘20’ is mapped to the input parameter associated with column IN_MAX_ROWS (e.g., parameter “MAX_ROWS”).

The parameters are initialized at S1215 based on the language of the function. For example, the Java Database Connector adapter may use default constructor and setter methods to initialize the corresponding parameters in ABAP. Other constructor and setter methods may be specified at design time.

The appropriate adapter may then be used to call the function at S1220 using the initialized parameters. In the present example, function provider 110 (e.g., the SAP ERP system) executes the function and returns values associated with the function's output parameters to query server 1120 at S1225. Query server 1120 maps the values to the output columns specified in the original query at S1230 based on the metadata associated with the function.

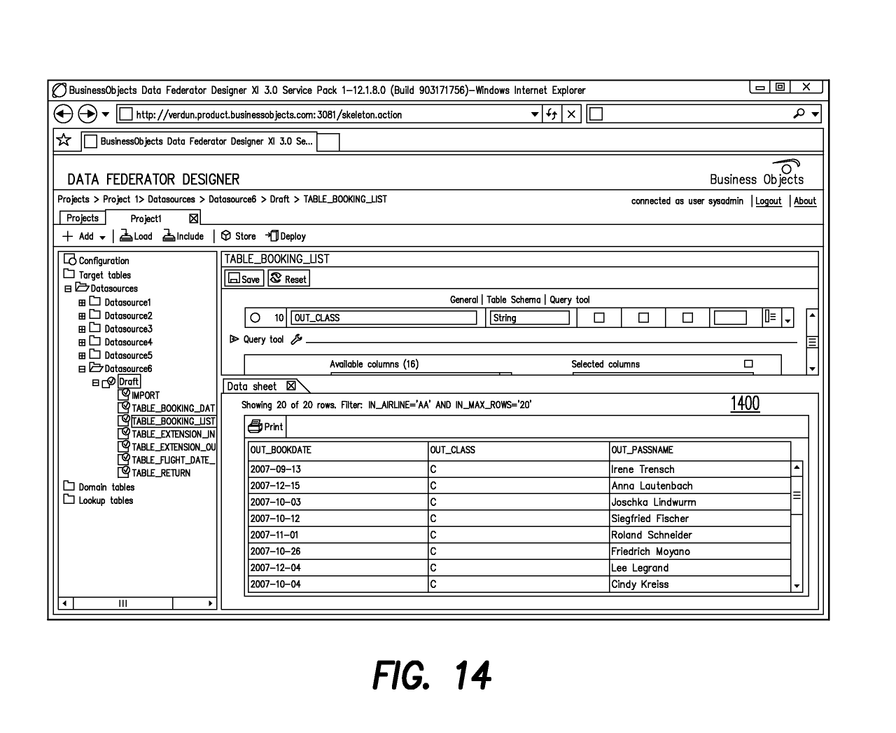

For example, query server 1120 may receive sets of values (i.e., rows) associated with the function's output parameters BOOKDATE, CLASS and PASSNAME at S1225. At S1230, these values are associated with table columns OUT_BOOKDATE, OUT_CLASS and OUT_PASSNAME based on the metadata defining table TABLE_BOOKING_LIST. FIG. 14 illustrates window 1400 presenting the received values as mapped to virtual table columns according to some embodiments.

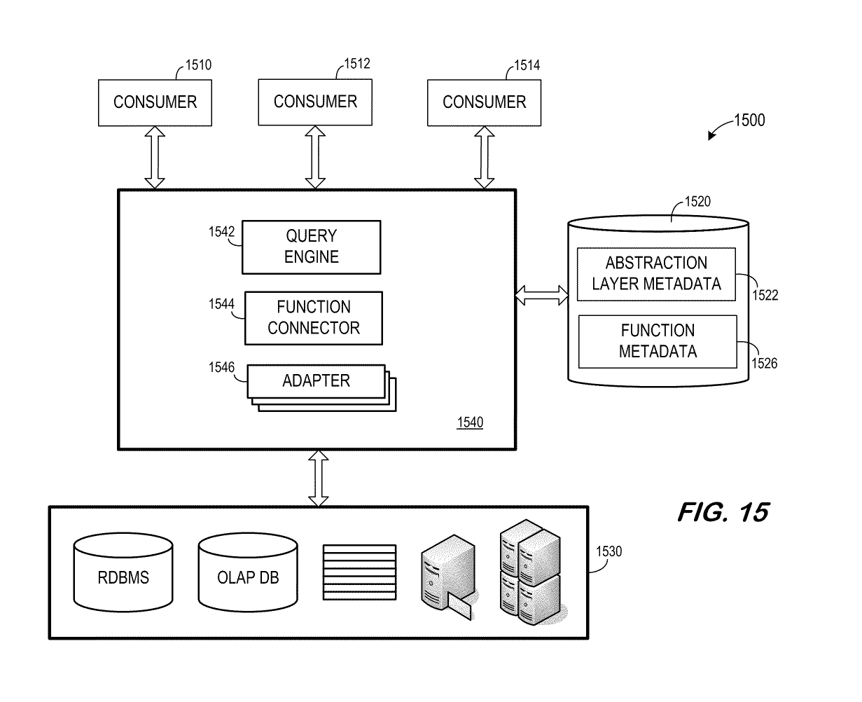

FIG. 15 is a block diagram of system 1500 to perform process 1200 according to some embodiments. Each element of system 1500 may include elements not illustrated in FIG. 15.

Consumers 1510 through 1514 may comprise software applications for object-based viewing of stored business data and/or creating object-based reports including stored business data. Examples of consumers 1510 through 1514 include BusinessObjects Web Intelligence, Crystal Reports, and BusinessObjects Explorer. Any number of consumers of one or more types may be supported according to some embodiments.

Central management system 1520 includes abstraction layer metadata 1522 corresponding to data stored among one or more of datasources 1530. Datasources 1530 include at least one function datasource as described herein. Embodiments are not limited to the number and types of datasources shown in FIG. 15.

Abstraction layer metadata 1522 includes metadata defining a set of “business objects” that represent business entities, such as customers, time, financial figures, etc. Business objects may be classified as dimensions (along which one may want to perform an analysis or report), details (e.g., additional information on dimensions), and measures (e.g., indicators, most often numeric, whose value can be determined for a given combination of dimension values). The metadata of abstraction layer metadata 1522 maps the business objects to logical entities of datasources 1530. Commonly-assigned and co-pending U.S. patent application Ser. No. 12/463,702 describes an abstraction layer, referred to therein as a semantic layer.

Abstraction layer metadata 1522 allows consumers 1510 through 1514 to query datasources 1530 using intuitive terms rather than references to specific physical entities of datasources 1530. For example, consumer 1510 may transmit a symbolic query including one or more of the business objects to information engine 1540. Information engine 1540 then generates an SQL query based on the symbolic query and the metadata of abstraction layer metadata 1522.

Query engine 1542 may receive the SQL query and determine that the query is associated with a function datasource. Query engine may therefore execute process 1200 in conjunction with function connector 1544, adapter 1546 and function metadata 1526 in order to execute the query. Information engine 1540 may receive the SQL-formatted results and provide the results in the desired object-based form to consumer 1510.

Accordingly, embodiments may facilitate the use of functions as datasources within existing systems. Moreover, embodiments may be compatible with systems designed to interface with multiple types of data sources and/or employing an object-based abstraction layer to facilitate interaction with underlying data.

Embodiments described herein are solely for the purpose of illustration. Those in the art will recognize other embodiments may be practiced with modifications and alterations to that described above.

What is claimed is:

1. A computer-implemented method comprising:
determining a plurality of parameters associated with a function;
determining columns of a table based on the plurality of parameters; and
generating metadata defining the columns of the table and mapping the columns to associated ones of the plurality of parameters.

2. A computer-implemented method according to claim 1, comprising:
generating a Structured Query Language query of the table based on the metadata, the query specifying a value of a first column of the table;
assigning the value to one of the plurality of parameters based on the metadata; and
calling the function with the assigned parameter value.

3. A computer-implemented method according to claim 2, further comprising:
receiving a value of an output parameter of the function in response to calling the function;
assigning the value of the output parameter to a second column of the table; and
returning a result of the query including the value of the second column of the table.

4. A computer-implemented method according to claim 1, wherein determining the columns of the table comprises:
determining a first plurality of the plurality of parameters, wherein each of the first plurality of the plurality of parameters correspond to a string data type, an integer data type, a Boolean data type, or a float data type; and
determining a respective column of the table associated with each of the first plurality of the plurality of parameters.

5. A computer-implemented method according to claim 4, wherein determining the columns of the table further comprises:
determining a second plurality of the plurality of parameters, wherein each of the second plurality of the plurality of parameters correspond to a class data type or a structure data type;
recursively splitting each of the second plurality of the plurality of parameters to create a hierarchy of parameters, each parameter of the hierarchy of parameters corresponding to a string data type, an integer data type, a Boolean data type, or a float data type; and
determining a respective column of the table associated with each parameter of the hierarchy of parameters.

6. A computer-implemented method according to claim 5,
wherein a name of a first column associated with a first parameter of the hierarchy of parameters indicates a parent parameter of the first parameter in the hierarchy.

7. A computer-implemented method according to claim 5, wherein determining the columns of the table further comprises:
determining a third plurality of the plurality of parameters, wherein each of the third plurality of the plurality of parameters correspond to a list data type; and
determining a respective table associated with each of the third plurality of the plurality of parameters.

8. A computer-readable medium having stored thereon program code, the program code executable by a processor to:
determine a plurality of parameters associated with a function;
determine columns of a table based on the plurality of parameters; and
generate metadata defining the columns of the table and mapping the columns to associated ones of the plurality of parameters.

9. A computer-readable medium according to claim 8, the program code further executable by a processor to:
generate a Structured Query Language query of the table based on the metadata, the query specifying a value of a first column of the table;
assign the value to one of the plurality of parameters based on the metadata; and
call the function with the assigned parameter value.

10. A computer-readable medium according to claim 9, the program code further executable by a processor to:
receive a value of an output parameter of the function in response to calling the function;
assign the value of the output parameter to a second column of the table; and
return a result of the query including the value of the second column of the table.

11. A computer-readable medium according to claim 8, wherein the program code executable by a processor to determine the columns of the table comprises program code executable by a processor to:
determine a first plurality of the plurality of parameters, wherein each of the first plurality of the plurality of parameters correspond to a string data type, an integer data type, a Boolean data type, or a float data type; and
determine a respective column of the table associated with each of the first plurality of the plurality of parameters.

12. A computer-readable medium according to claim 11, wherein the program code executable by a processor to determine the columns of the table comprises program code executable by a processor to:
determine a second plurality of the plurality of parameters, wherein each of the second plurality of the plurality of parameters correspond to a class data type or a structure data type;
recursively split each of the second plurality of the plurality of parameters to create a hierarchy of parameters, each parameter of the hierarchy of parameters corresponding to a string data type, an integer data type, a Boolean data type, or a float data type; and
determine a respective column of the table associated with each parameter of the hierarchy of parameters.

13. A computer-readable medium according to claim 12,
wherein a name of a first column associated with a first parameter of the hierarchy of parameters indicates a parent parameter of the first parameter in the hierarchy.

14. A computer-readable medium according to claim 12, wherein the program code executable by a processor to determine the columns of the table comprises program code executable by a processor to:
determine a third plurality of the plurality of parameters, wherein each of the third plurality of the plurality of parameters correspond to a list data type; and
determine a respective table associated with each of the third plurality of the plurality of parameters.

15. A system comprising:
an information designer to:
determine a plurality of parameters associated with a function;
determine columns of a table based on the plurality of parameters; and
generate metadata defining the columns of the table and mapping the columns to associated ones of the plurality of parameters.

16. A system according to claim 15, comprising:
a function provider to:
implement a software interface including the function; and
a query server to:
receive a Structured Query Language query of the table, the query specifying a value of a first column of the table;
assign the value to one of the plurality of parameters based on the metadata; and
call the function with the assigned parameter value.

17. A system according to claim 16,
the function provider to:
provide the query server with a value of an output parameter of the function in response to the function call, and
the query server to:
assign the value of the output parameter to a second column of the table; and
return a result of the query including the value of the second column of the table.

18. A system according to claim 15, wherein determination of the columns of the table comprises:
determination of a first plurality of the plurality of parameters, wherein each of the first plurality of the plurality of parameters correspond to a string data type, an integer data type, a Boolean data type, or a float data type; and
determination of a respective column of the table associated with each of the first plurality of the plurality of parameters.

19. A system according to claim 18, wherein determination of the columns of the table comprises:
determination of a second plurality of the plurality of parameters, wherein each of the second plurality of the plurality of parameters correspond to a class data type or a structure data type;
recursively splitting of each of the second plurality of the plurality of parameters to create a hierarchy of parameters, each parameter of the hierarchy of parameters corresponding to a string data type, an integer data type, a Boolean data type, or a float data type; and
determination of a respective column of the table associated with each parameter of the hierarchy of parameters.

20. A system according to claim 19,
wherein a name of a first column associated with a first parameter of the hierarchy of parameters indicates a parent parameter of the first parameter in the hierarchy.

21. A system according to claim 19, wherein determination of the columns of the table comprises:
determination of a third plurality of the plurality of parameters, wherein each of the third plurality of the plurality of parameters correspond to a list data type; and
determination of a respective table associated with each of the third plurality of the plurality of parameters.
